(19) United States
(12) Patent Application Publication
(10) Pub. No.: US 2012/0054588 A1
(43) Pub. Date: Mar. 1, 2012

(54) OUTPUTTING MEDIA CONTENT

(76) Inventors: Anbumani Subramanian, Bangalore (IN); Krishnan Ramanathan, Bangalore (IN)

(21) Appl. No.: 12/861,968

(22) Filed: Aug. 24, 2010

(51) Int. Cl. G06F 3/01; G06F 17/00

(52) U.S. Cl. 715/201; 715/702

(57) ABSTRACT

A computing device processes media content. A portion of a sensory area on the computing device is detected as being covered by an object. The media content is output by the computing device based at least in part on the portion of the sensory area that has been detected as being covered by the object.

### BACKGROUND

Previous to computers and related digital projection display technologies, over-head projectors and transparent slides, known as “transparencies,” were widely used in public presentations as visual aids. While over-head projectors are still used today, popular software programs, such as Microsoft PowerPoint, available from Microsoft Corporation of Redmond, Wash., have been created to facilitate public presentations using computers. Such computers are frequently connected to a digital projector for displaying presentations and other media content to an audience.

### BRIEF DESCRIPTION OF DRAWINGS

The following description includes discussion of figures having illustrations given by way of example of implementations of embodiments of the invention.

FIG. 1 is a block diagram illustrating a computing device according to various embodiments.

FIG. 2 is a block diagram illustrating a computing device according to various embodiments.

FIG. 3 is a block diagram illustrating a computing device according to various embodiments.

FIG. 4 is a flow diagram of operation in a computing device according to various embodiments.

### DETAILED DESCRIPTION

In the overhead projector paradigm described above, parts of a transparency can be hidden from audience view by covering the transparency with an opaque object such as a hand or a piece of paper. Accordingly, particular content on a transparency displayed to the audience can be easily manipulated by moving the opaque object (e.g., to uncover parts of the transparency, cover different sections of the transparency, etc.). Various embodiments described herein facilitate user control regarding which parts of a computer display are visible, for example, on a digitally projected display.

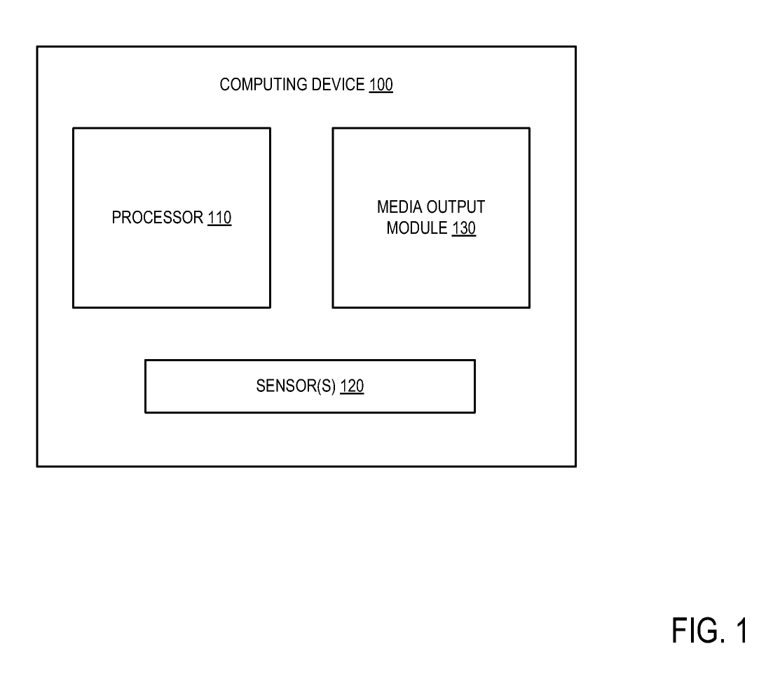

FIG. 1 is a block diagram of a computing device according to various embodiments. FIG. 1 includes particular components, modules, etc. according to various embodiments. However, in different embodiments, other components, modules, arrangements of components/modules, etc. may be used according to the teachings described herein. In addition, various components, modules, etc. described herein may be implemented as one or more software modules, hardware modules, special-purpose hardware (e.g., application specific hardware, application specific integrated circuits (ASICs), embedded controllers, hardwired circuitry, etc.), or some combination of these.

Computing device 100 includes a processor 110 to process media content. As used herein, media content refers to any visual and/or audio content that can be output by a computing device. For example, media content includes any content that might be displayed on a display screen or projected by a projector (e.g., a digital projector). In another example, media content includes any audio content that might be output by one or more speakers integrated with or connected to a computing device. More specifically, media content might include images, video, slide show presentations, music, etc.

Sensor(s) 120 are a collection of one or more sensors that sense a portion of a sensor area on computing device 100 that is covered by an object. For example, sensor(s) 120 could be a collection of one more touch and/or proximity sensors (e.g., surface capacitive, projected capacitive, optical, infrared, etc.) that detect touch, movement, and/or objects in a particular area on computing device 100. Touchscreens and touchpads are examples of particular areas on a computing device that are susceptible to sensing by one or more sensors. Embodiments are not limited to touchscreens and touchpads as sensor areas. In some embodiments, other surfaces on computing device 100 could be susceptible to sensing by one or more sensors and, therefore, be considered a sensor area. Thus, a sensor area, as used herein, refers to any area on a computing device (e.g., computing device 100) susceptible to sensing by one or more sensors (e.g., sensor(s) 120).

Sensor(s) 120 sense objects in a sensor area. In particular, sensor(s) 120 sense objects covering at least a portion of a sensor area. For example, sensor(s) 120 might detect a hand completely covering a touchpad. In another example, sensor(s) might detect a piece of paper covering part of a touchscreen or other sensor area. Depending on the type of sensor(s) used (e.g., touch sensors, proximity sensors, etc.), the detection of an object covering the sensor may or may not involve physically touching all or part of the sensor area. For example, in certain embodiments, an object (e.g., a hand, piece of paper, etc.) may fully cover a sensor area even though various portions of the sensor area may not be in direct physical contact with the object.

Media output module 130 outputs information to a media output device. As used herein, a media output device could be an internal or an external device (in relation to computing device 100). For example, a media output device could be a display screen on computing device 100 or it could be a digital projector connected to computing device 100. In another example, a media output device could be a speaker system integrated with computing device 100 or it could be a speaker system connected to computing device 100. In various embodiments, output information includes media content processed by processor 110 and information about how much, if any, of the sensor area is covered by an object. Thus, media output module 130 dictates which media content and/or how much of the available media content should be output by the media output device based on the portion of the sensor area covered by an object.

For example, media output module 130 might provide an image of a person's face to a media output device. With that image, media output module 130 might also provide information indicating that the right half of a sensor area is covered by an object. Accordingly, media output module 130 causes the media output device to display only the left half of the image of the person's face. The right half of the image might be blacked-out or otherwise obscured from a user's view. In another example, media output module 130 might provide an audio file (e.g., a song) to an audio output device. If half of the sensor area is covered by an object, media output module 130 might cause the audio output module to play the audio file at half of full volume corresponding to the half of the sensor area that is covered. Alternatively, the audio output module might play only half of the audio file corresponding to the half of the sensor area that is covered.

The information provided by media output module 130 is updated dynamically to reflect any changes detected by sensor(s) 120. Referring again to the example of the image of the person's face where only the left half of the image is displayed, the display is dynamically updated to display the full image of the persona's face in response to sensor(s) 120 sensing that the object is no longer covering the right half of the sensor area. Likewise, referring to the audio file example above, the volume level might be increased to full capacity in response to sensor(s) 120 detecting that the object is no longer covering half of the sensor area.

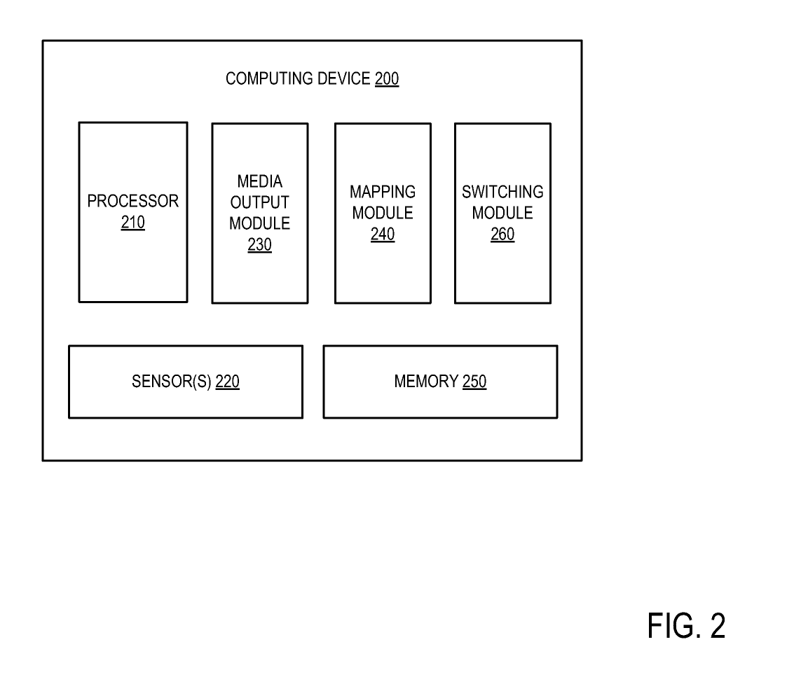

FIG. 2 is a block diagram illustrating a computing device according to various embodiments. FIG. 2 includes particular components, modules, etc. according to various embodiments. However, in different embodiments, other components, modules, arrangements of components/modules, etc. may be used according to the teachings described herein. In addition, various components, modules, etc. described herein may be implemented as one or hardware modules, special-purpose hardware (e.g., application specific hardware, application specific integrated circuits (ASICs), embedded controllers, hardwired circuitry, etc.), or some combination of these.

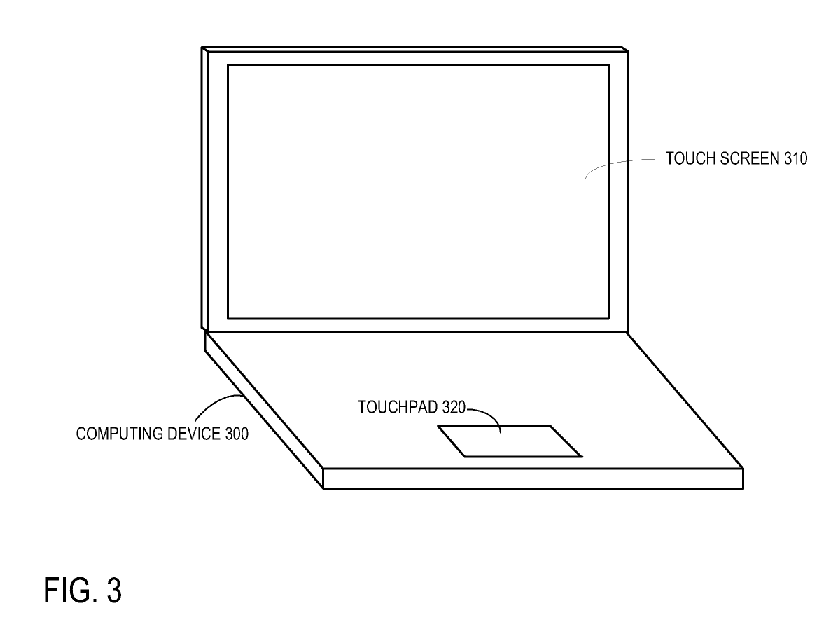

FIG. 2 is similar to FIG. 1 but includes the addition of various modules and components. Processor 210 processes media content including images, video, slide show presentations, documents, music and other audio files, etc. Sensor(s) 220 sense a portion of a sensor area on computing device 200 that is covered by an object. For example, sensor(s) 220 could be a collection of one more touch and/or proximity sensors (e.g., surface capacitive, projected capacitive, optical, infrared, etc.) that detect touch, movement, and/or objects in a particular area on computing device 100. Touchscreen 310 and touchpad 320 on computing device 300 of FIG. 3 are examples of particular areas on a computing device that are susceptible to sensing by one or more sensors. Other areas on a computing device susceptible to sensing by one or more sensors can also constitute sensor areas in different embodiments. Sensor areas that specifically involve touch sensors may also be referred to herein as touch areas.

Thus, sensor(s) 220 sense objects in a sensor area. In particular, sensor(s) 120 sense objects covering at least a portion of a sensor area. Mapping module 240 maps the sensor area to a display area of a display device and determines the portion of the display area to hide and/or obscure based on the portion of the sensor area covered by an object. For example, mapping module 240 may determine that a lower third of a sensor area is covered by an object and map the covered portion of the sensor area to pixels on a display screen such that the lower third of the display screen pixels are blacked-out, blank, or otherwise obscure the media content that would otherwise be displayed on the lower third portion of the display screen. In another example, sensor(s) 220 might sense a round coin covering a middle portion of the sensor area. Mapping module 240 maps the circular-covered portion of the sensor area to the display screen so that the obscured portion of the display screen is proportionate to the covered portion of the sensor area.

In some embodiments, mapping module 240 might map the covered portion of a sensor area on a percentage basis. For example, the media content provided by media output module 230 is an audio file, mapping module 240 might determine a percentage of the sensor area that is covered and map the percentage to a relative output audio level for playback of the audio file.

Switching module 260 switches media output module 230 into a different mode to cause the relevant media output device to ignore any covered portion of the sensor area. For example, computing device 200 might have two display modes—a “normal” mode and a “presentation” mode. When in the presentation mode, media output module 230 causes a display device to display only the portion of media content not covered by an object as determined by sensor(s) 220. However, when switching module 260 switches media output module 230 into normal mode (e.g., in response to user input), information regarding any covered portion of the sensor area is ignored and media output module 230 causes the display device to display all available media content.

In various embodiments, the functions of various modules (e.g., media output module 230, mapping module 240) may be implemented as a computer-readable storage medium via instructions executable by processor 210 and stored in memory 250.

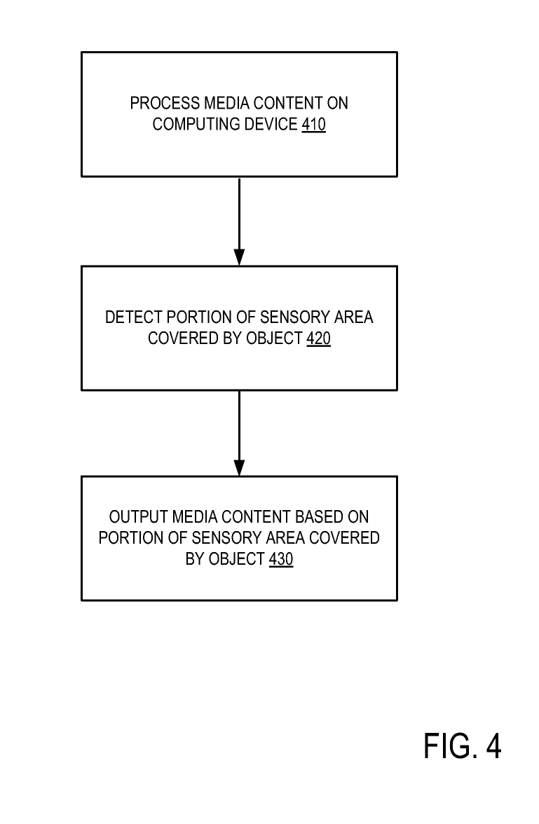

FIG. 4 is a flow diagram of operation in a vacuum control system according to various embodiments. FIG. 4 includes particular operations and execution order according to certain embodiments. However, in different embodiments, other operations, omitting one or more of the depicted operations, and/or proceeding in other orders of execution may also be used according to teachings described herein.

A computing device processes 410 media content. Processing media content may include processing image data, document data or other data for display on a display screen and/or a digital projector. Processing media could alternatively include processing audio data for output on a speaker or speaker system. In addition, media content could be a combination of audio and visual data (e.g., video data) for output on both a display and a speaker or speaker system.

One or more sensors on the computing device detect 420 a portion of a sensor area (e.g., a touchpad, touchscreen, etc.) covered by an object. The object could be a hand, a piece of paper, or any other object capable of being sensed by the one or more sensors. It should be noted that an object need not necessarily be opaque to be sensed by the one or more sensors. Sensors can be touch and/or proximity sensors using various technologies including, but not limited to, projected capacitance, surface capacitance, optics, resistive touch, etc.

Processed media content is output 430 based on the detected portion of the sensor area covered by the object. For example, the sensor area could be a touchpad (e.g., on a notebook computer) and the media content might be a slide show presentation displayed on a display screen (e.g., on the notebook computer). Alternatively, the sensor area could be a touchscreen (e.g., on a notebook, tablet, smartphone, etc.) and the media content might be a slide show presentation projected by a digital projector onto a display surface. In each example, the portion of the sensor area that is covered by an object is reflected in the output display. In other words, if a particular portion of the sensor area is determined to be covered (e.g., the upper right quadrant, the left half, the bottom third, or other portion, etc.), the corresponding portion of the output display will be blacked-out, hidden, or otherwise obscured from view.

Various modifications may be made to the disclosed embodiments and implementations of the invention without departing from their scope. Therefore, the illustrations and examples herein should be construed in an illustrative, and not a restrictive sense.

1. A method, comprising:
processing media content on a computing device;
detecting a portion of a sensory area on the computing device that is covered by an object; and
outputting the media content based at least in part on the detected portion of the sensory area that is covered by an object.

2. The method of claim 1, wherein the media content is visual and outputting the media content comprises:
mapping the detected portion of the sensory area covered by the object to a display area on the computing device; and
hiding a portion of the visual media content based at least in part on the mapping.

3. The method of claim 1, wherein the media content is audio media content and outputting the media content comprises:
automatically adjusting a volume associated with outputting the audio media content based at least in part on the portion of the sensory area covered by the object.

4. The method of claim 1, further comprising:
receiving user input to change a display mode on the computing device; and
switching the display mode to display all available content despite any portion of the sensory area being covered by the object.

5. A computing device, comprising:
a processor to process media content for output;
at least one sensor to sense a portion of a sensory area on the computing device covered by an object; and
a media output module to provide the media content and information about the portion of the sensory area covered by the object to a media output device to cause the media output device to output media content based at least in part on the portion of the sensory area covered by the object.

6. The computing device of claim 5, wherein the media content is visual content and the media output device is a display.

7. The computing device of claim 5, wherein the media content is audio content and the media output device is a speaker.

8. The computing device of claim 6, the display to hide visual content associated with a portion of the display corresponding to the portion of the sensory area covered by the object.

9. The computing device of claim 7, the speaker to output audio content at a volume level based on the size of the portion of the sensory area covered by the object.

10. A computing device, comprising:
a processor to process content for display;
at least one sensor to sense a portion of a touch area on the computing device covered by an object; and
a display module to provide the content for display and information about the portion of the touch area covered by the object to a display device to cause the display device to display content corresponding to the portion of the touch area not covered by the object and to hide content corresponding to the portion of the touch area covered by the object.

11. The computing device of claim 10, wherein the at least one sensor and the touch area constitute a touchpad on the computing device.

12. The computing device of claim 10, wherein the at least one sensor, the touch area, and the display device constitute a touchscreen display.

13. The computing device of claim 10, the display module further comprising:
a mapping module to map the touch area to a display area of the display device and to determine content associated with a portion of the display area to hide in view of the portion of the touch area covered by the object.

14. The computing device of claim 10, further comprising:
a switching module to switch the display module into a different mode to cause the display device to display content corresponding to the portion of the touch area covered by the object.

15. The computing device of claim 10, wherein the display device is an internal display device.

16. The computing device of claim 10, wherein the display device is an external display device.

17. A computer-readable storage medium containing instructions that, when executed, cause a computer to:
process content for display on a computing device;
detect a portion of a touch area on the computing device that is covered by an object;
display content corresponding to the portion of the touch area not covered by the object and to hide display content corresponding to the portion of the touch area covered by the object.

18. The computer-readable storage medium of claim 17, wherein the instructions that cause the displaying of content comprise further instructions that cause the computer to:
map the touch area to a display area; and
determine content associated with a portion of the display area to be hidden in view of the portion of the touch area covered by the object.
